(19) United States
(12) Patent Application Publication
(10) Pub. No.: US 2012/0025011 A1
(43) Pub. Date: Feb. 2, 2012

(54) AUTOGYRO WITH PRE-ROTATION

(76) Inventor: Thomas Hsueh, Anacortes, WA (US)

(21) Appl. No.: 13/191,677

(22) Filed: Jul. 27, 2011

Related U.S. Application Data
(60) Provisional application No. 61/367,995, filed on Jul. 27, 2010.

(51) Int. Cl. B64C 27/02

(52) U.S. Cl. 244/17.11

(57) ABSTRACT

The disclosed apparatus is an autogyro which utilizes a variable pitch propeller and an electric motor coupled to the lift rotor. At takeoff, the engine may be started with the thrust propeller at zero pitch and the lift rotor-driving electric motor is engaged to spin the lift rotor to the desired take off speed while the autogyro is still stationary on the ground. The pitch of the pusher propeller is switched from zero pitch to the take off power pitch so as to obtain desired forward thrust while the power to the lift rotor is switched off as the autogyro begins to lift off the ground. In this way the takeoff run may be relatively short. Also, if sufficient head wind is present, vertical takeoff would be possible.

### RELATED APPLICATIONS

This application claims priority benefit of U.S. Provisional Application Ser. No. 61/367,995, filed Jul. 27, 2010 and incorporated herein by reference.

### BACKGROUND OF THE DISCLOSURE

### Field of the Disclosure

The improvements disclosed herein are applicable to autogyro-type aircraft (generally referred to as autogiros, autogyros, gyroplanes and gyrocopters), such as the typical autogyro shown in FIG. 1 and the autogyro of U.S. Pat. No. 4,653,705 filed on Feb. 19, 1981 and incorporated herein by reference. Autogyros are distinguished from airplanes, which have a fixed wing and one or more propellers or other engines, and helicopters, which have one or more powered rotors.

An autogyro has a rotor that can turn freely on a vertical axis. Forward propulsion is provided by a conventional pusher or puller propeller. In forward flight the rotor disk is inclined backwards at a positive angle of attack resulting in aerodynamic forces which spin the rotor and produce lift. This generation of lift without application of power to the rotor is called autorotation.

The autogyro shown in FIG. 1 comprises a frame or body 22, a rotor 4, a rotor hub 6, a rotor mast 8, a rudder 24, a pusher propeller (the “propeller”) 26, which is powered by a main propulsion engine (the “engine”) 28, landing gear 16, and one or more seats 7.

Autogyros were quite popular in the 1930's and 1940's when they were used to carry mail between major U.S. cities. However, following the development of successful helicopters with their ability to hover as well as to take off and land vertically, autogyros fell out of favor. Today there is a renaissance of interest in the unique capabilities of the autogyro and ambitious new designs are being created.

One substantial advantage of an autogyro over a helicopter is that upon power failure the autogyro can achieve a safer landing. A successful helicopter autorotation landing following engine or transmission failure is also possible provided the helicopter is not flying at too low an altitude, but considerable pilot skill is required to control the descent rate to a safe landing.

With autogyros, given a loss of power to the thrust engine the pilot will nose the aircraft down to increase the forward speed and the rotational speed of the unpowered rotor, thus generating additional lift that can be utilized in a controlled landing. Just prior to touchdown and at just the right altitude the pilot would then flair the autogyro to reduce the speed to near zero for the landing. This also requires a certain level of pilot skill, but any error would be unlikely to cause serious harm to the occupants of the vehicle due to the low speed, although damage to the autogyro could result.

Autogyros are generally less mechanically complicated than helicopters, making them lighter, less prone to failure and less expensive to construct. They also differentiate from helicopters as there is normally no need for collective or cyclic pitch control of the rotor, although many autogyros do have collective pitch control, and some autogyros have cyclic pitch control as well.

### SUMMARY OF THE DISCLOSURE

The two major limitations of a conventional autogyro compared to a helicopter are its inability to takeoff vertically and to hover.

An autogyro rotor is not normally powered, thus the rotor needs to be brought up to speed before takeoff. In a conventional autogyro this is achieved by accelerating the aircraft forward by means of the propeller until the relative wind speed spins the rotor to takeoff rpm.

In order to reduce the takeoff distance, it has been recognized from the early days of autogyro development that it is necessary to pre-rotate the rotor while the autogyro was stationary on the ground. Various methods of achieving this have been attempted, most of which relied on engaging the main propulsion engine power through a mechanical device to pre-spin the rotor and then provide power to the propeller to begin the take off run. The available mechanical pre-spin devices on the market are not very satisfactory, chiefly because they are mechanically complex, switching power to and from the lift rotor takes time, and the lift rotor speed decays quickly. The devices are often fragile, underpowered and unreliable.

This disclosure describes a method of achieving vertical or near vertical autogyro takeoff which overcomes the above-mentioned difficulties.

### First Embodiment

The disclosed apparatus in a first embodiment utilizes a variable pitch propeller and a lightweight, low rpm high torque electric motor (or motors) in line with and directly coupled to the rotor shaft (or shafts). The motor may be powered by an on-board battery which may be charged by a generator coupled to the main propulsion engine or the battery may alternatively be charged directly by the generator. An electronic control system may be used to manage the power distribution from the electric motor, to the main propulsion engine and to a propeller pitch control mechanism, so as to achieve optimum performance. At takeoff, the engine may be started with the propeller at zero pitch and the rotor-driving electric motor is engaged to spin the lift rotor to the desired take off speed while the autogyro is still stationary on the ground. To achieve flight, the pitch of the pusher propeller may be switched from zero pitch to the take off power pitch so as to obtain desired forward thrust while the power to the lift rotor is switched off as the autogyro begins to lift off the ground. In this way the rotor speed decay is little or none and the takeoff run may be relatively short. Also, if sufficient head wind is present, vertical takeoff would be possible.

### Second Embodiment

The disclosed apparatus in a second embodiment incorporates a collective rotor pitch control system to the first embodiment. The takeoff procedure is the same as in the first embodiment, except that the pitch of the rotor blades may be changed from zero to normal flight mode as soon as the pusher propeller provides maximum forward thrust. Again, the exact power flow sequence to the electric motor, engine, rotor and propeller pitch control could be managed by an electronic control system so as to optimize the autogyro performance. With this second version a vertical takeoff and landing can be achieved.

Both disclosed embodiments allow safer landing in case of engine failure than is achievable with a conventional autogyro because power is available to drive the rotor through the electric motor just prior to touchdown allowing for a lower touchdown forward speed. In the second version, the rotor pitch can also be changed to provide lift and maintain lift rotor speed, allowing the pilot to use the collective pitch to control the decent rate and make a softer landing. An electronic control system could also be programmed to optimize the landing procedure.

### BRIEF DESCRIPTION OF THE DRAWINGS

FIG. 1 is an isometric view of a prior art autogyro.

FIG. 2 is a side view of an autogyro lift mechanism with the common components shown in FIG. 1 removed to more clearly show the improvement, in one form.

FIG. 3 is a top view of the autogyro lift mechanism in one form, as shown in FIG. 2.

FIG. 4 is a front view of the autogyro lift mechanism in one form, as shown in FIG. 2.

FIG. 5 is an isometric, side view of a portion of the autogyro lift mechanism in one form, as shown in FIG. 2.

FIG. 6 is a highly schematic diagram of the power routing system, in one form.

### DESCRIPTION OF THE PREFERRED EMBODIMENTS

Disclosed herein is a system to enable an autogyro aircraft to take off using a much shorter runway and to land more safely.

Conventional autogyros rely on relative wind speed to spin the lift rotor until it reaches the take off rpm, or use a mechanical device coupled to the main propulsion (thrust) engine to pre-spin the lift rotor. Power is then diverted to the thrust propeller to start the takeoff run to reduce takeoff distance. The available mechanical pre-spin devices on the market are not very satisfactory, chiefly because mechanically coupling power to and from the rotor takes time and the rotor speed decays quickly. The devices are fragile, underpowered, and often unreliable.

In an autogyro according using the new system, a user would position the autogyro for takeoff, use a lift rotor electric motor to establish pre-rotation of the lift rotor, engage a main propulsion engine with the pitch of the pusher propeller at zero. Once the lift rotor is rotating at the desired speed, a interlink (switch) could be actuated as part of a flight control unit, substantially simultaneously disconnecting power to the lift rotor electric motor, and increasing the pitch of the thrust propeller substantially reducing the distance required for takeoff. In one form, the interlink may also automatically adjust a lift rotor pitch actuator, further shortening the distance required for takeoff.

Upon approach to the landing area at the conclusion of a flight, the lift rotor electric motor could be re-engaged, establishing additional lift to counter a potential stall situation, improving the likelihood of a safe and gentle landing.

### First Embodiment

The first disclosed embodiment in one form uses a lightweight, low rpm high torque electric motor or motors in line with, and directly or indirectly coupled to the rotating shaft of one or more lift rotors. The lift rotor electric motor is separate from the main propulsion engine, in one form, a standard DC motor is utilized for the lift rotor electric motor. The lift rotor electric motor is powered by on-board battery or by an engine driven generator.

In function, a user would position the autogyro for takeoff, set the propeller pitch to zero, start the engine and then activate the electric motor to establish pre-rotation of the rotor. Once the rotor has reached the desired rpm, the pilot would activate the interlink which would automatically increase the pitch of the propeller and disconnect power to the rotor as soon as sufficient forward speed to sustain autorotation is achieved. The pilot would most likely be applying full engine power to the thrust propeller. The exact sequence of operations at takeoff could be managed by an electronic control unit programmed to minimize the takeoff distance.

Upon approach to the landing area at the conclusion of a flight, the rotor electric motor could be re-engaged to improve the likelihood of a safe and gentle landing, particularly in case of engine failure.

### Second Embodiment

The author's second embodiment, in one form, adds a collective rotor pitch control system to the first version embodiment and may be used in conjunction with the first embodiment.

As in the first embodiment, the pilot would set the propeller pitch to zero, start the propulsion engine and then activate a switch to energize the electric motor to establish pre-rotation of the rotor. The pitch of the rotor blades would initially be at zero setting, thus producing no lift, and the rotor would be accelerated to a higher than normal flight rpm. When the rotor has reached the desired rpm, the propeller pitch would be increased while applying full engine power and simultaneously switching the rotor blades to normal flight mode pitch just prior to disconnecting power to the rotor motor. The resulting sudden surge of rotor lift produced by the stored kinetic energy at the higher rpm will cause the autogyro to “jump” into the air and continue climbing upon application of full engine power. This will result in a near vertical takeoff of the aircraft.

As in the first embodiment, an electronic control unit can be added, programmed to manage the sequence of operations for optimum performance. In case of engine failure, during the final landing stage when the pilot needs to flair the aircraft to reduce speed just prior to touchdown, the ability to apply power to the rotor and to change the rotor pitch would result in a safer landing. In this case an electronic control to assist in this maneuver would be an added benefit.

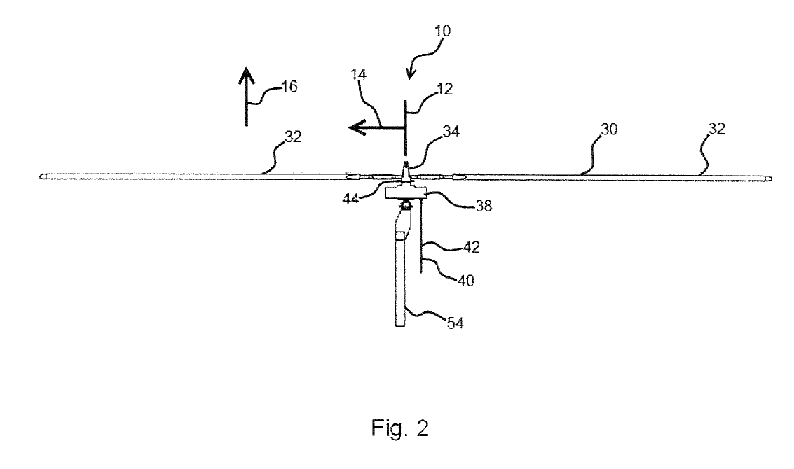

Before beginning a detailed description, an axis system 10 is shown in FIG. 2 comprising a central axis of rotation 12 around which the lift rotor rotates, a radially outward axis 14, as well as a vertical axis 16. These axes are not intended to be limiting to the disclosure, but simply are incorporated to ease in understanding of the invention.

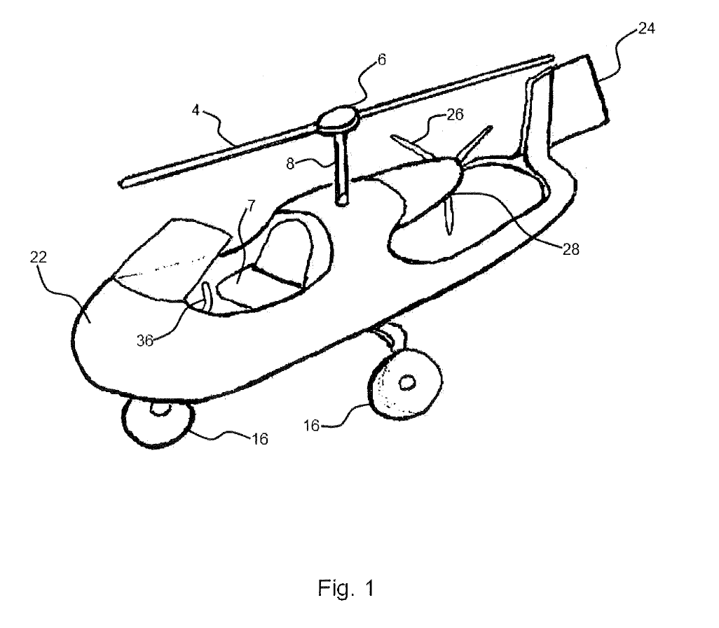

Looking to FIG. 2, a lift rotor 30 is shown comprising blades 32, which in one form are fixed pitch and in another form are variable pitch. Each of the blades 32 couples to the autogyro 20 through a rotor hub 34, which in the variable pitch embodiment also adjusts the pitch of the blades as desired by the user. In FIG. 1, one embodiment of a control stick 36 is shown, which is mechanically coupled to the rotor hub of that embodiment, however, hydraulic, mechanical, or electric pitch control mechanisms could be utilized. As disclosed above, electric pitch control devices have substantial benefits in the improved embodiments.

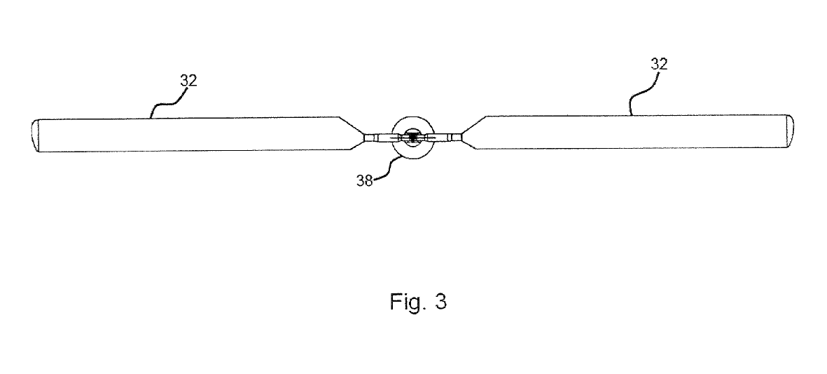

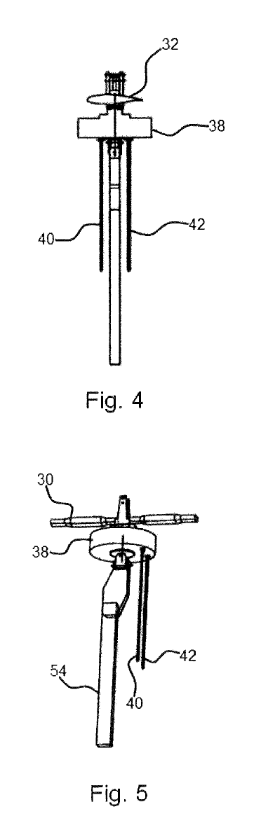

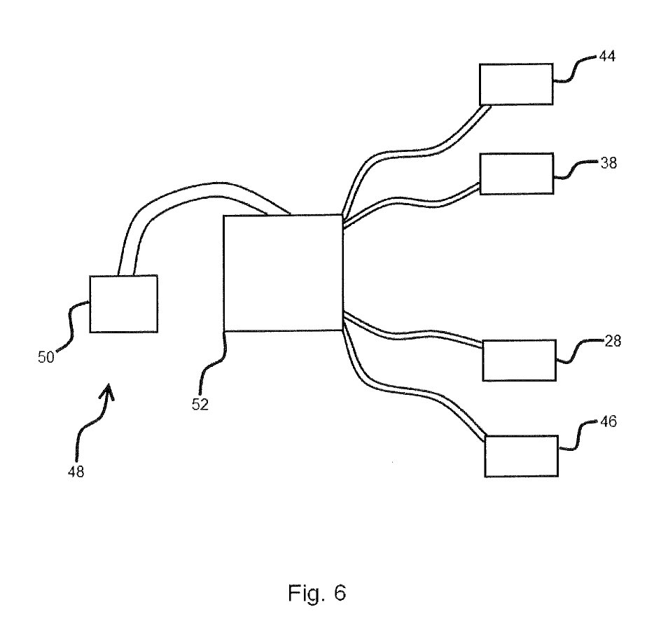

The rotor hub 34 shown in FIGS. 2-5 is mechanically coupled to a lift rotor electric motor 38 having inputs 40 and 42, which are more easily seen in FIG. 4 which more clearly shows the electrical connections between the individual components. In one form, the input 40 provides power to the lift rotor electric motor, while the input 42 provides power and control to a lift rotor pitch actuator 44. This arrangement is also shown in FIG. 6 in a highly schematic way. If an embodiment is utilized with a variable pitch pusher propeller 26, a pusher propeller pitch actuator 46 may also be utilized.

FIG. 6 shows one way or embodiment in which a power routing system 48 may be utilized, comprising a power supply, such as a battery 50, and electronics comprising a flight control unit 52 connected to the battery and receiving power therefrom. The flight control unit 52 is further electrically coupled to the lift rotor pitch actuator 44, lift electric motor 38, main propulsion engine 28, and pusher propeller pitch actuator 46.

Continuing with the assembly or connectivity of the elements shown in FIG. 2, the lift rotor electric motor 38 and optional lift rotor pitch actuator 44 are coupled to the autogyro mast 54 or other parts of the frame member 22, described in reference to FIG. 1.

In one form, there is no provision on-board to recharge the battery 50, as it is generally held that any wind-powered generator/alternator would produce more drag than desired, and a solar cell would not be efficient due to weight and windage concerns. However, it may be possible to incorporate such devices using technology available or yet to be discovered as of the filing of this disclosure.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. An autogyro aircraft comprising:
a. a frame;
b. a forward thrust variable pitch propeller rotateably coupled to the frame;
c. a lift rotor rotateably coupled to the frame, where the lift rotor is generally not powered during flight of the autogiro;
d. an electric thrust motor coupled to rotate the forward thrust propeller relative to the frame to provide forward thrust to the autogyro aircraft;
e. an electric lift motor coupled to rotate the lift rotor relative to the frame prior to takeoff to provide lift to the autogyro aircraft; and
f. a thrust-lift interlink which disengages the lift motor and simultaneously changes the pitch of the thrust propeller from neutral thrust to forward thrust.

2. The autogyro aircraft as recited in claim 1 wherein the exact sequence of operations at takeoff is managed by an electronic control unit programmed to minimize the takeoff distance.

3. The autogyro aircraft as recited in claim 1 wherein the lift rotor is a variable pitch rotor.
